(19) United States
(12) Patent Application Publication
(10) Pub. No.: US 2025/0340044 A1
(43) Pub. Date: Nov. 6, 2025

(54) Gypsum Panel Having a Perforated Facing Material

(71) Applicant: Gold Bond Building Products, LLC, Charlotte, NC (US)

(72) Inventor: Michael N. Blades, Indian Land, SC (US)

(21) Appl. No.: 19/196,993

(22) Filed: May 2, 2025

Related U.S. Application Data
(60) Provisional application No. 63/642,116, filed on May 3, 2024.

(51) Int. Cl. B32B 13/08; B32B 13/04; B32B 13/06; B32B 17/04; B32B 37/12; E04C 2/26

(52) U.S. Cl. CPC B32B 13/08; B32B 13/047; B32B 13/06; B32B 17/04; B32B 37/12; E04C 2/26; B32B 2607/00

(57) ABSTRACT

The present invention is directed to a gypsum panel having one or more perforations and a method of making such gypsum panel. For instance, in some aspects, the gypsum panel comprises a gypsum core, a first facing material, and a second facing material. The first facing material, the second facing material, or both may include a multilayer facing material having one or more perforations. Notably, one layer of the multilayer facing material may be a polymer layer.

### RELATED APPLICATIONS

The present application is based on and claims priority to U.S. Provisional Patent Application Ser. No. 63/642,116, filed on May 3, 2024, which is incorporated herein by reference in its entirety.

### BACKGROUND OF THE INVENTION

Gypsum panels are commonly employed in drywall construction of interior walls and ceilings and also have other applications. Generally, these gypsum panels are formed from a gypsum slurry including a mixture of calcined gypsum (i.e., stucco), water, and other conventional additives. The mixture is cast and allowed to set by reaction of the stucco with the water. Notably, in various applications, gypsum panels may include facing materials having a plurality of layers. However, incorporating a plurality of layers into a facing material may have various drawbacks. For instance, when a gypsum panel is being manufactured, the gypsum panel may be exposed to heat via a heating or drying device, such as a kiln or an oven. The heat provided by the heating or drying device may cause at least a portion of the water in the gypsum core of the gypsum panel to vaporize. Notably, a facing material having a plurality of layers may reduce or prevent water vapor from escaping the gypsum panel, which may result in deformities, such as blisters and/or bubbles, to one or more of the facing materials of a gypsum panel. Additionally, the plurality of layers of a facing material may interfere with the drying of the gypsum panel, which may reduce the facing material to gypsum core bond.

As a result, there is a need to provide an improved gypsum panel that reduces or prevents deformations in facing materials having a plurality of layers.

### SUMMARY OF THE INVENTION

Aspects and advantages of the invention will be set forth in part in the following description, or may be obvious from the description, or may be learned through practice of the invention.

In accordance with one embodiment of the present invention, a gypsum panel is disclosed. The gypsum panel comprises: a gypsum core comprising gypsum; a first facing material and a second facing material, the first facing material, the second facing material, or both being a multilayer facing material, wherein at least one multilayer facing material of the gypsum panel comprises a polymer; and one or more perforations, the one or more perforations having a variable diameter or a variable width over at least a portion of a length of the one or more perforations, the one or more perforations being present in the at least one multilayer facing material.

In some aspects, one or more perforations have a width or a diameter from about 0.1 mm to about 50 mm, such as from about 0.1 mm to about 20 mm.

In some aspects, one or more perforations comprise two adjacent perforations, the two adjacent perforations being spaced from each other by a distance of about 200 mm on center or less, such as from about 1 mm on center or more to about 100 mm on center or less.

In some aspects, a multilayer facing material comprises a polymer. In some aspects, a multilayer facing material comprises paper. In some aspects, a multilayer facing material comprises a fiberglass layer.

In some aspects, one or more perforations comprise at least three perforations that are in-line, the at least three perforations forming a row parallel with the width of the gypsum panel. In some aspects, one or more perforations comprise at least two perforations that are staggered.

In some aspects, one or more perforations are present in two or more layers of at least one multilayer facing material. In some aspects, one or more perforations are not present in every layer of the at least one multilayer facing material.

In some aspects, at least one multilayer facing material comprises a layer closest to the gypsum core, wherein one or more perforations are not present in the layer of the at least one multilayer facing material closest to the gypsum core.

In some aspects, at least a portion of one or more perforations is tapered. In some aspects, at least a portion of at least one perforation is tapered, the at least one perforation having a perforation taper angle of about 0.5° or more.

In some aspects, the one or more perforations are in the form of a polyhedron. In some aspects, the one or more perforations define a hollow or annular shape that includes a remaining portion of a facing material layer of the multilayer facing material.

In some aspects, at least one multilayer facing material comprises a layer closest to the gypsum core, wherein one or more perforations are not present in the layer of the at least one multilayer facing material closest to the gypsum core; and at least a portion of at least one perforation is tapered, the at least one perforation having a perforation taper angle of about 0.5° or more.

In accordance with one embodiment of the present invention, a gypsum panel is disclosed. The gypsum panel comprises: a gypsum core comprising gypsum; a first facing material and a second facing material, the first facing material, the second facing material, or both being a multilayer facing material; wherein at least one multilayer facing material comprises a first facing material layer and a second facing material layer, the first facing material layer being an inner facing material layer closest to the gypsum core; and one or more perforations, the one or more perforations being present in the at least one multilayer facing material, the one or more perforations (e.g., all of the perforations) not being present in the first facing material layer.

In some aspects, at least one multilayer facing material comprises a third facing material layer, the third facing material layer being an outer facing material layer; and one or more perforations are present in the second facing material layer, the third facing material layer, or both.

In some aspects, a second facing material layer comprises a polymer.

In accordance with one embodiment of the present invention, a method of making a gypsum panel is disclosed. The method comprises: providing a first facing material; depositing a gypsum slurry comprising stucco and water onto the first facing material; providing a second facing material on the gypsum slurry; and allowing the stucco to convert to calcium sulfate dihydrate; wherein the first facing material, the second facing material, or both are a multilayer facing material; wherein the method further comprises forming one or more perforations in at least one multilayer facing material, the one or more perforations having a variable diameter or a variable width over at least a portion of the length of the one or more perforations; wherein the gypsum slurry forms a gypsum core.

In some aspects, at least one multilayer facing material comprises a layer closest to the gypsum core, wherein one or more perforations are not present in the layer of the at least one multilayer facing material closest to the gypsum core; and at least a portion of at least one perforation is tapered, the at least one perforation having a perforation taper angle of about 0.5° or more.

In some aspects, a second facing material layer comprises a polymer.

In some aspects, one or more perforations are formed in at least one multilayer facing material prior to providing the first facing material. In some aspects, one or more perforations are formed in at least one multilayer facing material after providing the second facing material.

In accordance with another embodiment of the present invention, a gypsum panel is disclosed. The gypsum panel comprises: a gypsum core comprising gypsum; a first facing material and a second facing material, the first facing material, the second facing material, or both being a multilayer facing material; wherein at least one multilayer facing material comprises a first facing material layer and a second facing material layer, the first facing material layer being an inner facing material layer adjacent to the gypsum core, and one or more perforations, the one or more perforations being present in the at least one multilayer facing material, the one or more perforations not being present in the first facing material layer.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a rear view of one embodiment of a gypsum panel in accordance with aspects of the present subject matter;

FIG. 2 illustrates a side view of one embodiment of a gypsum panel in accordance with aspects of the present subject matter;

FIG. 3 illustrates a side view of one embodiment of a perforation in accordance with aspects of the present subject matter;

FIG. 4 illustrates a side view of another embodiment of a perforation in accordance with aspects of the present subject matter;

FIG. 5 illustrates a rear view of another embodiment of a gypsum panel in accordance with aspects of the present subject matter;

FIG. 6 illustrates one embodiment of a system for forming perforations in a gypsum panel in accordance with aspects of the present subject matter; and

FIG. 7 illustrates one embodiment of a wallboard assembly in accordance with aspects of the present subject matter.

Repeat use of reference characters in the present specification and drawings is intended to represent the same or analogous features or elements of the present invention.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum panel and a method of making such gypsum panel. In particular, the gypsum panel can include one or more facing materials comprising a plurality of layers. In this regard, the gypsum panel may include one or more multilayer facing materials. Notably a first facing material and/or a second facing material may be a multilayer facing material. The present inventors have discovered that the gypsum panel disclosed herein can have various benefits due to the use of a multilayer facing material comprising one or more perforations. The one or more perforations may be formed in one or more layers of a multilayer facing material. Notably, the inclusion of a multilayer facing material comprising one or more perforations may result in a gypsum panel having enhanced properties and characteristics. For instance, the gypsum panel disclosed herein may have increased sound dampening characteristics, an enhanced appearance, fire resistance, impact resistance, and/or increased strength (e.g., nail pull strength). In some aspects, the gypsum panel disclosed herein may have self-sealing capabilities, such as the sealing of one or more perforations (e.g., fastener perforations).

It should be understood that throughout the entirety of this specification, each numerical value (e.g., weight percentage, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value.

It should be understood that, unless stated otherwise, any standard listed herein (e.g., ASTM) is the most recent version available as of the latest revision year. Further, it should be understood that throughout the entirety of this specification, the term “and/or” refers to one or all of the listed components or a combination of any two or more of the listed components. Notably, some aspects of the present invention may omit one or more of the features disclosed herein.

In general, a gypsum panel formed in accordance with the present disclosure may include a gypsum core. Generally, the gypsum core may be sandwiched by facing materials (e.g., first facing material, second facing material). The facing materials may include any facing material as generally employed in the art. The facing material may be a paper facing material, a fibrous (e.g., glass fiber) mat facing material (e.g., glass mat facing material), a metal facing material (e.g., an aluminum facing material), or a polymeric facing material. In general, the first facing material and the second facing material may be the same type of material. Alternatively, the first facing material may be one type of material while the second facing material may be a different type of material. In one aspect, the first facing material and the second facing material may comprise the same binder (e.g., a polymeric binder). In another aspect, the first facing material and the second facing material may comprise a different binder. In an additional aspect, the first facing material and/or the second facing material may not comprise a polymeric binder.

In general, a glass mat facing material in one embodiment may be coated. However, in one particular embodiment, the glass mat facing material may not have a coating, such as a coating that is applied to the surface of the mat.

Notably, as previously disclosed herein, a facing material in accordance with the present disclosure may be a multilayer facing material. Generally, the multilayer facing material may include two or more layers, such as three or more layers, such as four or more layers, such as five or more layers. In general, a multilayer facing material may have six layers or less, such as five layers or less, such as four layers or less, such as three layers or less. In general, a multilayer facing material formed in accordance with the present disclosure may have an outer facing material layer and an inner facing material layer. The “inner facing material layer” is the layer of a facing material that is closest to (e.g., adjacent to) a gypsum core and/or gypsum core layer. The “outer facing material layer” is the facing material layer opposite the inner facing material layer. The outer facing material layer faces away from the gypsum core. Notably, in some aspects, one or more perforations may be formed or present in the outer facing material layer, but not the inner facing material layer. In some aspects, one or more perforations may be formed or present in a facing material layer between an outer facing material layer and an inner facing material layer. For instance, when a polymer layer is between an outer facing material layer and an inner facing material layer, the polymer layer may have one or more perforations formed therein or therethrough. Notably, in some aspects, one or more perforations may be formed in all, such as three, facing material layers of a facing material (e.g., first facing material, second facing material). In some aspects, two or more perforations may be formed in a different number of facing material layers of a facing material. For instance, a first perforation may be formed in two facing material layers, such as any of the facing material layers disclosed herein, and a second perforation may be formed in three facing material layers, such as any of the facing material layers disclosed herein. In some aspects, two or more perforations may be formed in the same number of facing material layers of a facing material.

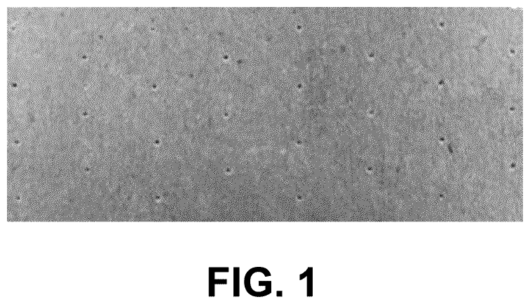

Referring now to FIG. 1, FIG. 1 illustrates an outer facing material layer having perforations therein.

In general, two or more layers of a multilayer facing material may sandwich one or more layers of a multilayer facing material. Notably, two or more layers that sandwich one or more layers may be made of the same material or may be made of different material. For instance, when two or more layers of a multilayer facing material sandwich one or more layers and are made of the same material, the two layers may be paper layers.

In general, one or more layers of the multilayer facing material may include paper, fiberglass, one or more metals, one or more polymers, or a combination thereof. In this respect, a multilayer facing material may include one or more paper layers, one or more fiberglass layers, one or more metal layers, one or more polymer layers, or a combination thereof. In some preferred aspects, one or more polymer layers may include a viscoelastic polymer. Notably, a polymer (e.g., a viscoelastic polymer) may function as an adhesive between two or more layers of a multilayer facing material, such as two or more paper layers.

Generally, a multilayer facing material may include one or more polymer layers comprising a polymeric material that functions as a sound dampening layer. In some aspects, the polymer layer may comprise a resin. Notably, a polymeric material may include one or more polymers, one or more copolymers, or a combination thereof. In some aspects, the polymeric material may include one or more elastomers, one or more latex polymers, one or more acrylic polymers, one or more acrylic copolymers, or a combination thereof.

In general, a polymer layer may comprise various additives. For instance, a polymer layer may include anti-microbial materials for fungal protection and appropriate fillers such as, in non-limiting examples, vermiculite, expanded mica, talc, lead, granulated polystyrene, aluminum oxide, or a combination thereof. Some aspects in accordance with the present disclosure include a tacky adhesive constructed of one or more polymers having fluidity at an ordinary temperature and one or more emulsion type or solvent type polymers consisting of one or more natural rubbers, synthetic rubbers, and polymers such as, in non-limiting examples, acrylic resin and silicone resin. Notably, a tackifier, including such non-limiting examples as petroleum resin and sap, a softener, and/or a plasticizer may be included in a polymer layer. Other non-limiting examples of materials used to form a polymer layer may include polyester resins, resins constructed from plasticizers or peroxide being added to polyester, multiple polyesters, polyurethane foam, polyamide resin, ethylene-vinyl acetate copolymers, ethylene acrylic acid copolymers, polyurethane copolymers, EPDM polymers, or a combination thereof. In some aspects, a polymer layer may comprise a polymer having a dynamic glass transition temperature at or below the working temperature at which the polymer layer and/or gypsum panel will be used.

Notably, in some aspects, the polymer layer may be provided as a glue, such as a viscoelastic glue. Once applied, the glue may be dried in order to form the polymer layer. Such viscoelastic glue is distinguishable from a polymeric sheet that is simply positioned and may not require any drying to provide a sound dampening effect. As previously disclosed herein, the polymer layer may function as an adhesive or glue between two or more other facing material layers.

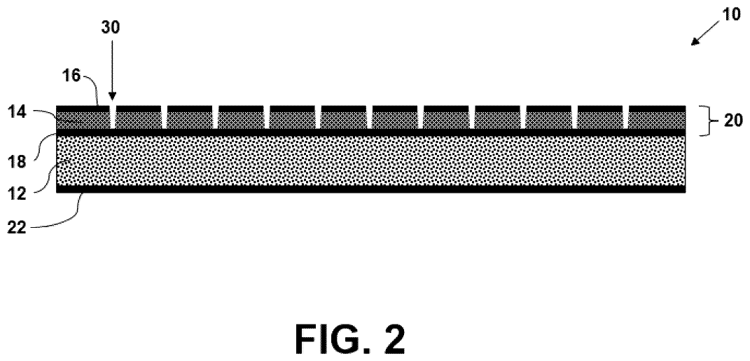

Notably, the two or more layers of a multilayer facing material, including any layers disclosed herein, may be in any order. For instance, as illustrated in FIG. 2, a gypsum panel 10 may include a gypsum core 12, a facing material 22, and a multilayer facing material 20. The multilayer facing material 20 has a first layer 18, a second layer 14, and a third layer 16. Notably, in FIG. 2, the first layer 18 is a paper facing material, the second layer 14 is a viscoelastic polymer, and the third layer 16 is a paper facing material. However, it should be understood, as previously disclosed herein, that one or more of the layers of the multilayer facing material may comprise any of the facing material layer materials previously disclosed herein. As further illustrated in FIG. 2, a gypsum panel 10 may include a multilayer facing material 20 having a plurality of perforations 30.

As previously disclosed herein, a facing material (e.g., a multilayer facing material) formed in accordance with the present disclosure may include a plurality of perforations. It should be understood that the formation of a perforation may not result in the removal of material of one or more layers of the facing material from the gypsum panel. In this respect, the perforations of the present disclosure may not be formed by taking plugs of one or more layers of the facing material out of the respective layer(s) of the facing material. Notably, the formation of the perforations may push material of the one or more facing material layers to the area of the facing material surrounding the perforation. For instance, the formation of the perforations may push material from the perforated portion of the one or more facing material layers toward or into the surrounding portion of the respective layer(s) of a facing material that remains after the perforation. In this respect, the perforations of the present disclosure may form densified regions of facing material surrounding the perforations. These densified regions may have a higher density than the portion(s) of a facing material non-adjacent to the perforations.

In general, a perforation may extend through or be present in at least a portion of the thickness of a facing material. Notably, a perforation may extend through or be present in one or more layers of a multilayer facing material. Generally, a perforation may extend through or be present in one layer of a multilayer facing material or more, such as two layers or more, such as three layers or more, such as four layers or more, such as five layers or more. In some aspects, a perforation may extend through or be present in six layers of a multilayer facing material or less, such as five layers or less, such as four layers or less, such as three layers or less, such as two layers or less. In general, a perforation may not extend through or be present in all of the layers of a multilayer facing material. For instance, FIG. 2 illustrates an aspect where a plurality of perforations 30 are present in the third layer 16 and the second layer 14 of the multilayer facing material 20. However, the plurality of perforations 30 are not present in the first layer 18 of the multilayer facing material 20. In this respect, one or more perforations may not extend through or be present in the layer of a multilayer facing material closest to (e.g., adjacent to) a gypsum core and/or a gypsum core layer. Notably, in FIG. 2, the third layer 16 is the outer facing material layer and the first layer 18 is the inner facing material layer.

In some aspects, one or more perforations of a facing material (e.g., a multilayer facing material) may have a constant width or a variable width. For cylindrical perforations, one or more perforations of a facing material (e.g., a multilayer facing material) may have a constant diameter or a variable diameter. As used herein, a perforation having a “variable width” or “variable diameter” refers to a perforation where the width or diameter respectively of the perforation changes over at least a portion of the length of the perforation. As used herein, the perforation length is the dimension of a perforation generally perpendicular to the facing material (e.g., in the thickness direction of the gypsum panel). Notably, a variable width or variable diameter may allow for an increased amount of water vapor exiting the gypsum core. For instance, the location and/or size of a long base and/or a short base of a perforation may affect the amount of water vapor exiting the gypsum core. Further, for instance, the degree of taper of a perforation may affect the amount of water vapor exiting the gypsum core. Additionally, a variable width or variable diameter may allow for enhanced sound dampening properties. For instance, the location and/or size of a long base and/or a short base of a perforation may affect the sound dampening properties of a gypsum panel. Further, for instance, the degree of taper of a perforation may affect the sound dampening properties of a gypsum panel.

In general, one or more perforations may be 3-dimensional. The one or more perforations may be a polyhedron (e.g., regular polyhedron, irregular polyhedron). In some aspects, one or more perforations may be cylindrical, conical, rectangular, triangular, starred, hexagonal, octagonal, annular (ring-shaped), or a combination thereof. In some aspects, one or more perforations may define a hollow or annular shape that includes a remaining portion of the facing material layer (e.g., first facing material layer, second facing material layer, third facing material layer) and/or a facing material (e.g., first facing material, second facing material) within the perimeter of the respective perforation. In some aspects, a perforation may be both cylindrical and conical. In some aspects, a perforation may be cylindrical for about 0% to about 100%, including all increments of 1% therebetween, of the length of the perforation. For instance, a perforation may be cylindrical for about 0% or more of the length of the perforation, such as about 10% or more, such as about 20% or more, such as about 30% or more, such as about 40% or more, such as about 50% or more, such as about 60% or more, such as about 70% or more, such as about 80% or more, such as about 90% or more. In general, a perforation may be cylindrical for about 100% or less of the length of the perforation, such as about 90% or less, such as about 80% or less, such as about 70% or less, such as about 60% or less, such as about 50% or less, such as about 40% or less, such as about 30% or less, such as about 20% or less, such as about 10% or less.

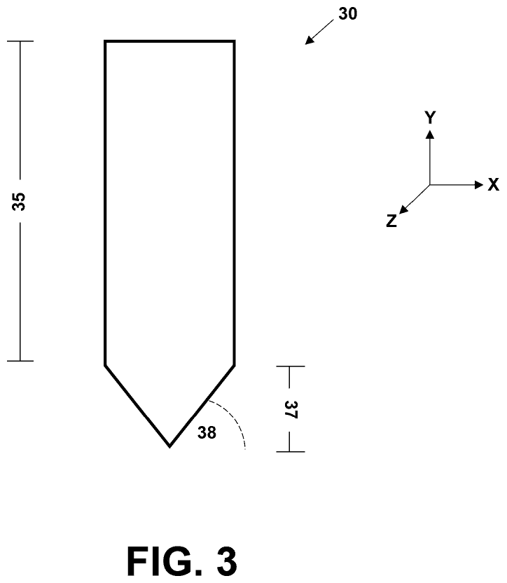

Generally, a perforation may have a singular diameter or singular width for about 0% to about 100%, including all increments of 1% therebetween, of the length of a perforation, such as about 80% or less, such as about 60% or less, such as about 40% or less. A perforation may have a singular diameter or singular width for about 0% or more of the length of the perforation, such as about 10% or more, such as about 20% or more, such as about 30% or more, such as about 40% or more, such as about 50% or more, such as about 60% or more, such as about 70% or more, such as about 80% or more, such as about 90% or more. In general, a perforation may have a singular diameter or singular width for about 100% or less of the length of the perforation, such as about 90% or less, such as about 80% or less, such as about 70% or less, such as about 60% or less, such as about 50% or less, such as about 40% or less, such as about 30% or less, such as about 20% or less, such as about 10% or less. Notably, FIG. 3 illustrates a perforation 30, having a singular diameter or singular width over the length 35, which is less than 100% of the length of the perforation 30.

In some aspects, at least a portion of a perforation may be tapered. For instance, a perforation may be tapered from about 0% to about 100%, including all increments of 1% therebetween, of the length of a perforation, such as about 40% or more, such as about 60% or more, such as about 80% or more. A perforation may be tapered for about 0% or more of the length of the perforation, such as about 10% or more, such as about 20% or more, such as about 30% or more, such as about 40% or more, such as about 50% or more, such as about 60% or more, such as about 70% or more, such as about 80% or more, such as about 90% or more. In general, a perforation may be tapered for about 100% or less of the length of the perforation, such as about 90% or less, such as about 80% or less, such as about 70% or less, such as about 60% or less, such as about 50% or less, such as about 40% or less, such as about 30% or less, such as about 20% or less, such as about 10% or less. Notably, FIG. 3 illustrates a perforation 30 having a taper over a length 37.

As further illustrated in FIG. 3, a perforation 30 may have a perforation taper angle 38. The perforation taper angle 38 is determined on the x-y plane as illustrated in FIG. 3. The initial side of the angle is parallel to the bottom of the taper and the terminal side of the angle is the line of the taper itself. In this respect, the terminal side of the angle is in-line with the taper of the perforation. Generally, a perforation may have a perforation taper angle of about 0.5° or more, such as about 10° or more, such as about 20° or more, such as about 30° or more, such as about 40° or more, such as about 50° or more, such as about 60° or more, such as about 70° or more, such as about 80° or more. In general, a perforation may have a perforation taper angle of about 90° or less, such as about 80° or less, such as about 70° or less, such as about 60° or less, such as about 50° or less, such as about 40° or less, such as about 30° or less, such as about 20° or less, such as about 10° or less. Notably, the angle of a perforation taper angle may allow for an increased amount of water vapor exiting the gypsum core. Further, the angle of a perforation taper angle may allow for enhanced sound dampening properties.

In some aspects, a perforation may have a perforation taper angle of from about 0.5° to about 90°, such as about 2° to about 80°, such as about 5° to about 75°, such as about 15° to about 70°.

Generally, in some aspects, a perforation may have two or more perforation taper angles that are the same angle. In some aspects, a perforation may have two or more perforation taper angles that are different angles.

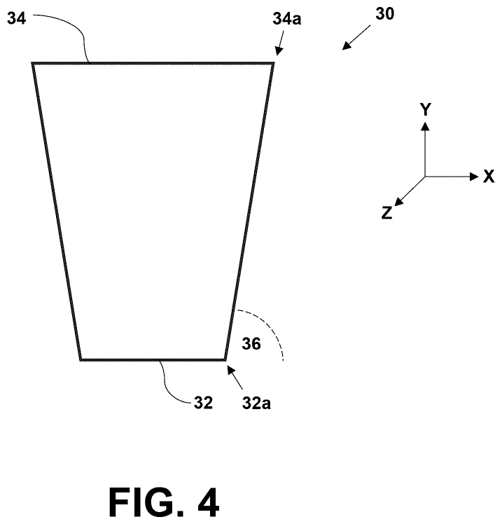

In general, a perforation may have a short base and a long base. As used herein, the “short base” is the end of a perforation having a smaller area as compared to the long base. As used herein, the “long base” is the end of a perforation having a larger area as compared to the short base. For instance, FIG. 4 illustrates a perforation 30 having a short base 32 and a long base 34. Generally, a perforation may have a long base that has an area about 1% larger than the area of the short base or more, such as about 5% larger or more, such as about 10% larger or more, such as about 20% larger or more, such as about 30% larger or more, such as about 40% larger or more, such as about 50% larger or more, such as about 60% larger or more, such as about 70% larger or more, such as about 80% larger or more, such as about 90% larger or more, such as about 100% larger or more, such as about 150% larger or more, such as about 200% larger or more, such as about 300% larger or more, such as about 400% larger or more, such as about 500% larger or more, such as about 1000% larger or more, such as about 5000% larger or more. In some aspects, a perforation may have a long base that has an area about 10000% larger than the area of the short base or less, such as about 5000% larger or less, such as about 4000% larger or less, such as about 3000% larger or less, such as about 2000% larger or less, such as about 1000% larger or less.

As further illustrated in FIG. 4, a perforation 30 may have a perforation base angle 36. The perforation base angle 36 is determined by drawing a line between an end of the short base 32a and the end of the long base 34a that is closest to the previously mentioned end of the short base 32a. The angle is determined on the x-y plane as illustrated in FIG. 4. The initial side of the angle is parallel to the short base and the terminal side of the angle is the line between the end of the short base and the end of the long base that is closest to the previously mentioned point on the short base. Generally, a perforation may have a perforation base angle of about 0.5° or more, such as about 10° or more, such as about 20° or more, such as about 30° or more, such as about 40° or more, such as about 50° or more, such as about 60° or more, such as about 70° or more, such as about 80° or more. In general, a perforation may have a perforation base angle of about 90° or less, such as about 80° or less, such as about 70° or less, such as about 60° or less, such as about 50° or less, such as about 40° or less, such as about 30° or less, such as about 20° or less, such as about 10° or less. Notably, the angle of a perforation base angle may allow for an increased amount of water vapor exiting the gypsum core. Further, the angle of a perforation base angle may allow for enhanced sound dampening properties.

Generally, in some aspects, a perforation may have two or more perforation base angles that are the same angle. In some aspects, a perforation may have two or more perforation base angles that are different angles.

In some aspects, a perforation of a facing material (e.g., a multilayer facing material) and/or any layer thereof may have a width or diameter from about 0.1 mm to about 50 mm, including all increments of 1 mm therebetween. For instance, a perforation of a facing material and/or any layer thereof may have a width or diameter of about 0.1 mm or more, such as about 1 mm or more, such as about 5 mm or more, such as about 10 mm or more, such as about 20 mm or more, such as about 30 mm or more, such as about 40 mm or more. In general, a perforation of a facing material and/or any layer thereof may have a width or diameter of about 50 mm or less, such as about 40 mm or less, such as about 30 mm or less, such as about 20 mm or less, such as about 10 mm or less. It should be understood that the aforementioned widths and diameters refer to the largest width or diameter obtained by the perforation in the facing material (e.g., multilayer facing material) and/or any layer thereof. In some aspects, the aforementioned widths and diameters may refer to the width or diameter of the long base of a perforation.

As used herein, the term “on center” (“o.c.”) refers to the measurement from the center of one perforation to the center of the next perforation. Notably, two or more perforations, such as two or more adjacent perforations, may be spaced from one another by a distance from about 0.5 mm to about 500 mm, including all increments of 1 mm therebetween. For instance, two or more perforations may be spaced from one another by a distance of about 0.5 mm on center or more, such as about 1 mm on center or more, such as about 2 mm on center or more, such as about 3 mm on center or more, such as about 4 mm on center or more, such as about 5 mm on center or more, such as about 6 mm on center or more, such as about 7 mm on center or more, such as about 8 mm on center or more, such as about 9 mm on center or more, such as about 10 mm on center or more, such as about 15 mm on center or more, such as about 25 mm on center or more, such as about 50 mm on center or more, such as about 100 mm on center or more, such as about 150 mm on center or more, such as about 200 mm on center or more, such as about 300 mm on center or more, such as about 400 mm on center or more. In general, two or more perforations, such as two or more adjacent perforations, may be spaced from one another by a distance of about 500 mm on center or less, such as about 400 mm on center or less, such as about 300 mm on center or less, such as about 200 mm on center or less, such as about 150 mm on center or less, such as about 100 mm on center or less, such as about 50 mm on center or less, such as about 25 mm on center or less, such as about 15 mm on center or less, such as about 10 mm on center or less, such as about 9 mm on center or less, such as about 8 mm on center or less, such as about 7 mm on center or less, such as about 6 mm on center or less, such as about 5 mm on center or less, such as about 4 mm on center or less, such as about 3 mm on center or less, such as about 2 mm on center or less, such as about 1 mm on center or less.

In general, three or more perforations may be spaced at regular intervals. For instance, three or more perforations may be spaced at regular intervals of about 0.5 mm on center or more, such as about 1 mm on center or more, such as about 2 mm on center or more, such as about 3 mm on center or more, such as about 4 mm on center or more, such as about 5 mm on center or more, such as about 6 mm on center or more, such as about 7 mm on center or more, such as about 8 mm on center or more, such as about 9 mm on center or more, such as about 10 mm on center or more, such as about 15 mm on center or more, such as about 25 mm on center or more, such as about 50 mm on center or more, such as about 100 mm on center or more, such as about 150 mm on center or more, such as about 200 mm on center or more, such as about 300 mm on center or more, such as about 400 mm on center or more. In general, three or more perforations may be spaced at regular intervals of about 500 mm on center or less, such as about 400 mm on center or less, such as about 300 mm on center or less, such as about 200 mm on center or less, such as about 150 mm on center or less, such as about 100 mm on center or less, such as about 50 mm on center or less, such as about 25 mm on center or less, such as about 15 mm on center or less, such as about 10 mm on center or less, such as about 9 mm on center or less, such as about 8 mm on center or less, such as about 7 mm on center or less, such as about 6 mm on center or less, such as about 5 mm on center or less, such as about 4 mm on center or less, such as about 3 mm on center or less, such as about 2 mm on center or less, such as about 1 mm on center or less.

Generally, the perforations per unit area present in a facing material (e.g., a multilayer facing material) may be from about 1 perforation/in² to about 50 perforations/in2, including all increments of 1 perforation/in² therebetween. For instance, the perforations per unit area present in a facing material may be about 1 perforation/in² or more, such as about 5 perforations/in² or more, such as about 10 perforations/in² or more, such as about 15 perforations/in² or more, such as about 20 perforations/in² or more, such as about 25 perforations/in² or more, such as about 30 perforations/in² or more. In general, the perforations per unit area present in a facing material may be about 50 perforations/in² or less, such as about 40 perforations/in² or less, such as about 30 perforations/in² or less, such as about 25 perforations/in² or less, such as about 20 perforations/in² or less, such as about 15 perforations/in² or less, such as about 10 perforations/in² or less, such as about 5 perforations/in² or less.

In general, two or more perforations (e.g., three or more perforations) may be in-line or may be staggered. In some aspects, two or more perforations (e.g., three or more perforations) may be in-line in a direction parallel to the length (e.g., longest dimension) of the gypsum panel. In this respect, two or more perforations may form one or more columns on a facing material formed in accordance with the present disclosure. In some aspects, two or more perforations (e.g., three or more perforations) may be in-line in a direction parallel to the width of the gypsum panel. In this respect, two or more perforations may form one or more rows on a facing material formed in accordance with the present disclosure.

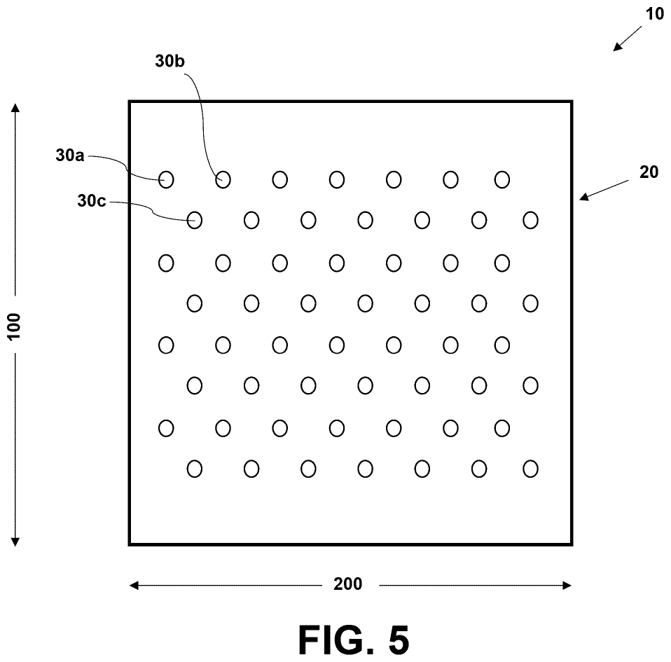

As illustrated in FIG. 5, a gypsum panel 10 may include perforations 30a and 30b that are in-line in a direction parallel with the width 200 of the gypsum panel. Further, FIG. 5 illustrates that two or more perforations, such as perforations 30a and 30c, may be staggered. In this respect, the perforations of the multilayer facing material 20 of the gypsum panel 10 of FIG. 5 may not form columns, but may only form rows. In some aspects, a gypsum panel 10 may include perforations that are in-line in a direction parallel with the length, or largest dimension, 100 of the gypsum panel 10. It should be understood that, in some aspects, the perforations of a facing material of a gypsum panel formed in accordance with the present disclosure may not form rows, but may only form columns. In some aspects, at least a portion of the perforations of a facing material may form both columns and rows.

In some aspects, one or more perforations may be formed in one or more facing materials (e.g., first facing material, second facing material) and/or any layer thereof of a gypsum panel before, during, and/or after any of the process steps disclosed herein. In some aspects, one or more perforations may be formed in the second facing material after the second facing material is provided or placed onto the gypsum slurry but before the gypsum panel is supplied to a heating or drying device to undergo a heating or drying process. In some aspects, one or more perforations may be formed in the first facing material after the first facing material is provided. Generally, one or more perforations may be formed in one or more facing materials (e.g., first facing material, second facing material) of a gypsum panel in an offline process. The perforations may be formed in one or more facing materials (e.g., first facing material, second facing material) before the facing material is utilized in the manufacturing process of the gypsum panel.

In general, a perforation roller may include a plurality of pins for forming perforations. Notably, a perforation roller may form one or more perforations in one or more facing materials (e.g., first facing material, second facing material) and/or any layer thereof of a gypsum panel before, during, and/or after any of the process steps disclosed herein. In general, a perforation roller may form one or more perforations in one or more facing materials (e.g., first facing material, second facing material) and/or any layer thereof of a gypsum panel online during the manufacturing process disclosed herein. In some aspects, a perforation roller may form perforations in the second facing material after the second facing material is provided or placed onto the gypsum slurry but before the gypsum panel is supplied to a heating or drying device to undergo a heating or drying process. In some aspects, a perforation roller may form perforations in the first facing material after the first facing material is provided. In some aspects, a perforation roller may form perforations in one or more facing materials (e.g., first facing material, second facing material) of a gypsum panel in an offline process. When utilized in an offline process, the perforation roller may form one or more perforations in one or more facing materials (e.g., first facing material, second facing material) before the facing material is utilized in the manufacturing process of the gypsum panel.

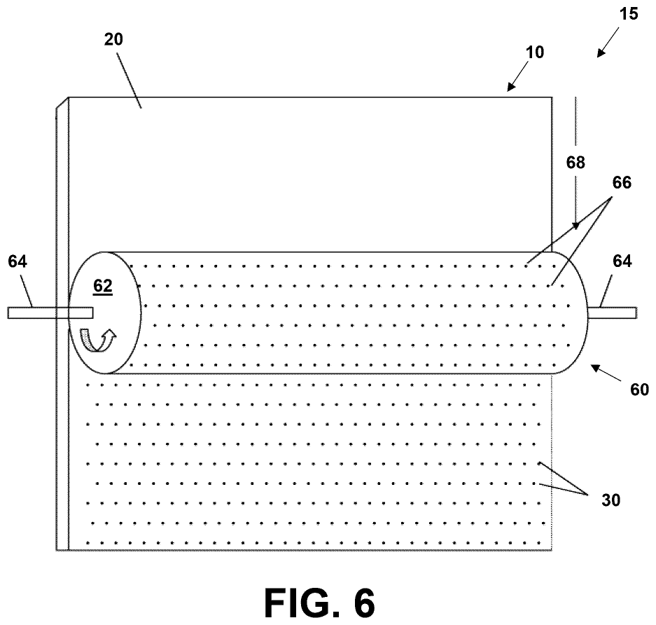

Referring to FIG. 6, FIG. 6 illustrates a system 15 having a perforation roller 60 that includes a cylinder 62, a shaft 64, and a plurality of pins 66 for forming perforations 30 in a multilayer facing material 20 of a gypsum panel 10. As further illustrated in FIG. 6, during the process of forming a gypsum panel 10, the gypsum panel 10 may move beneath a perforation roller 60 in the direction 68. Generally, the movement of the gypsum panel 10 may be facilitated by a conveyor assembly, such as a continuous belt or fabric.

Generally, one or more pins used to form the perforations may possess any of the properties, characteristics, structures, and/or geometries of a perforation as disclosed herein.

In general, one or more pins of the plurality of pins may have a constant width or a variable width. As used herein, a pin having a “variable width” or “variable diameter” refers to a pin where the width or diameter respectively of the pin changes over at least a portion of the length of the pin.

In general, one or more pins may be 3-dimensional. The one or more pins may be a polyhedron (e.g., regular polyhedron, irregular polyhedron). In some aspects, one or more pins may be cylindrical, conical, rectangular, triangular, starred, hexagonal, octagonal, annular (ring-shaped), or a combination thereof. In some aspects, one or more pins may be solid structures that correspond to the shape of the perforations or may be configured as hollow or annular structures that form perforations surrounding an unperforated portion of a facing material layer (e.g., first facing material layer, second facing material layer, third facing material layer) and/or a facing material (e.g., first facing material, second facing material). In some aspects, a pin may be cylindrical for about 0% to about 100%, including all increments of 1% therebetween, of the length of the pin. For instance, a pin may be cylindrical for about 0% or more of the length of the pin, such as about 10% or more, such as about 20% or more, such as about 30% or more, such as about 40% or more, such as about 50% or more, such as about 60% or more, such as about 70% or more, such as about 80% or more, such as about 90% or more. In general, a pin may be cylindrical for about 100% or less of the length of the pin, such as about 90% or less, such as about 80% or less, such as about 70% or less, such as about 60% or less, such as about 50% or less, such as about 40% or less, such as about 30% or less, such as about 20% or less, such as about 10% or less.

Generally, a pin may have a singular diameter or singular width for about 0% to about 100%, including all increments of 1% therebetween, of the length of a pin, such as about 80% or less, such as about 60% or less, such as about 40% or less, such as about 20% or less. A pin may have a singular diameter or singular width for about 0% or more of the length of the pin, such as about 10% or more, such as about 20% or more, such as about 30% or more, such as about 40% or more, such as about 50% or more, such as about 60% or more, such as about 70% or more, such as about 80% or more, such as about 90% or more. In general, a pin may have a singular diameter or singular width for about 100% or less of the length of the pin, such as about 90% or less, such as about 80% or less, such as about 70% or less, such as about 60% or less, such as about 50% or less, such as about 40% or less, such as about 30% or less, such as about 20% or less, such as about 10% or less.

In some aspects, at least a portion of a pin may be tapered. For instance, a pin may be tapered from about 0% to about 100%, including all increments of 1% therebetween, of the length of a pin, such as about 20% or more, such as about 40% or more, such as about 60% or more. A pin may be tapered for about 0% or more of the length of the pin, such as about 10% or more, such as about 20% or more, such as about 30% or more, such as about 40% or more, such as about 50% or more, such as about 60% or more, such as about 70% or more, such as about 80% or more, such as about 90% or more. In general, a pin may be tapered for about 100% or less of the length of the pin, such as about 90% or less, such as about 80% or less, such as about 70% or less, such as about 60% or less, such as about 50% or less, such as about 40% or less, such as about 30% or less, such as about 20% or less, such as about 10% or less.

In general, the gypsum core may comprise calcium sulfate dihydrate. The gypsum used to make the gypsum core may be from a natural source, a synthetic source, and/or from reclaim and is thus not necessarily limited by the present invention. In general, the gypsum, in particular the calcium sulfate dihydrate, may be present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum may be present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In some aspects, the gypsum core may also comprise other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In yet another embodiment, the aforementioned weight percentages may be based on the weight of the gypsum in the respective gypsum core layer.

In general, a gypsum panel formed in accordance with the present disclosure may be formed from a method as disclosed herein. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In general, the composition of the gypsum slurry is not necessarily limited and may be any generally known in the art. Generally, in one embodiment, the gypsum core is made from a gypsum slurry including at least stucco and water.

In general, stucco may be referred to as calcined gypsum or calcium sulfate hemihydrate. The calcined gypsum may be from a natural source or a synthetic source and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be anhydrite (e.g., AII, AIII), α-hemihydrate, β-hemihydrate, or a mixture thereof.

In addition to the stucco, the gypsum slurry may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

As indicated above, the gypsum slurry may include water. Water may be employed for fluidity and also for rehydration of the gypsum to allow for setting.

The weight ratio of the water to the stucco may be 0.1 or more, such as 0.2 or more, such as 0.2 or more, such as 0.3 or more, such as 0.4 or more, such as 0.5 or more, such as 0.6 or more, such as 0.7 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

In one aspect, the foaming agent may include one or more foam stabilizers, such as ethoxylated glycerin. The one or more foam stabilizers may be present in the gypsum slurry and/or gypsum core in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less by weight of the foaming agent. The one or more foam stabilizers may be present in the gypsum slurry and/or gypsum core in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more by weight of the foaming agent.

By utilizing a soap, foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less. Notably, the aforementioned values may be based on the gypsum core.

In one aspect, the gypsum slurry and/or gypsum core may include a dispersant. The dispersant is not necessarily limited and may include any that can be utilized within the gypsum slurry. The dispersant may include carboxylates, sulfates, sulfonates, phosphates, mixtures thereof, etc.

In one embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate. In one embodiment, the phosphate may be sodium monofluorophosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less. Notably, the aforementioned values may be based on the gypsum core.

In some aspects, the gypsum slurry and/or gypsum core may include one or more surfactants. In general, the surfactant may be an anionic surfactant, a cationic surfactant, a non-ionic surfactant, a fluorinated surfactant, a silicon surfactant, or a mixture thereof. Generally, a surfactant may be in the form of a solid, a liquid, or a combination thereof.

As indicated above, in one embodiment, the surfactant may include an anionic surfactant. In general, anionic surfactants include those having one or more negatively charged functional groups. For instance, the anionic surfactant may include an alkali metal or ammonium salts of alkyl, aryl or alkylaryl sulfonates, sulfates, or a mixture thereof. In some aspects, the anionic surfactant may include ammonium lauryl sulfate, sodium lauryl sulfate, sodium octylphenol glycolether sulfate, sodium laureth sulfate, sodium myreth sulfate, sodium dodecylbenzene sulfonate, perfluorobutane sulfonate, dodecyl benzene sulfonate, alpha-olefin sulfonate, sodium lauryldiglycol sulfate, ammonium tritertiarybutyl phenol and penta- and octa-glycol sulfonates, sulfosuccinate salts such as disodium ethoxylated nonylphenol half ester of sulfosuccinic acid, disodium n-octyldecyl sulfosuccinate, sodium dioctyl sulfosuccinate, alpha olefin sulfonate and/or olefin sulfonate (e.g., sodium olefin sulfonates, such as sodium C₁₄-C₁₆ olefin sulfonate, sodium C₁₄-C₁₈ olefin sulfonate, and sodium C₁₆-C₁₈ olefin sulfonate), and mixtures thereof. Other examples include a C₈-C₂₂ alkyl fatty acid salt of an alkali metal, alkaline earth metal, ammonium, alkyl substituted ammonium, for example, isopropylamine salt, or alkanolammonium salt, a C₈-C₂₂ alkyl fatty acid ester, a C₈-C₂₂ alkyl fatty acid ester salt, and alkyl ether carboxylates. Further, the anionic surfactant may include a phosphate (alkyl-aryl ether phosphates, alkyl ether phosphates, etc.), a phosphite, a phosphonate, a carboxylate (e.g., sodium stearate, etc.), or a mixture thereof.

In one particular embodiment, the anionic surfactant may include a water-soluble salt, particularly an alkali metal salt, of an organic sulfur reaction product having in their molecular structure an alkyl radical containing from about 8 to 22 carbon atoms and a radical selected from the group consisting of sulfonic and sulfuric acid ester radicals. Organic sulfur based anionic surfactants include the salts of C₁₀-C₁₆ alkylbenzene sulfonates, C₁₀-C₂₂ alkane sulfonates, C₁₀-C₂₂ alkyl ether sulfates, C₁₀-C₂₂ alkyl sulfates, C₄-C₁₀ dialkylsulfosuccinates, C₁₀-C₂₂ acyl isothionates, alkyl diphenyloxide sulfonates, alkyl naphthalene sulfonates, C₁₀-C₂₀ alpha olefin sulfonates, and 2-acetamido hexadecane sulfonates. In one aspect, the anionic surfactant may include C₆-C₁₂ linear and/or branched alkyl sulfates and/or C₆-C₁₂ linear and/or branched alkyl ether sulfates. Organic phosphate based anionic surfactants include organic phosphate esters such as complex mono-or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Particular examples of anionic surfactants include a polyoxyethylene alkyl ether sulfuric ester salt, a polyoxyethylene alkylphenyl ether sulfuric ester salt, polyoxyethylene styrenated alkylether ammonium sulfate, polyoxymethylene alkylphenyl ether ammonium sulfate, and the like, and mixtures thereof. For instance, the anionic surfactant may include a polyoxyethylene alkyl ether sulfuric ester salt, a polyoxyethylene alkylphenyl ether sulfuric ester salt, or a mixture thereof. In some aspects, the anionic surfactant may include sulfated alkanolamide, glyceride sulfate, or a mixture thereof.

As indicated above, in one embodiment, the surfactant may include a non-ionic surfactant. In one aspect, the nonionic surfactant may be an amine oxide. In one aspect, the nonionic surfactant may be an ethoxylate. For instance, the nonionic surfactant may be an ethoxylated fatty alcohol, a linear alcohol ethoxylate (e.g., narrow-range ethoxylate, octaethylene glycol monododecyl ether, pentaethylene glycol monododecyl ether, etc.), an alkylphenol ethoxylate (e.g., a nonoxynol, octylphenol ethoxylate, etc.), a fatty acid ethoxylate, an ethoxylated fatty ester, or an ethoxylated amine. In some aspects, the nonionic surfactant may be and/or include fatty acid amides (e.g., polyethoxylated tallow amine, cocamide monoethanolamine, cocamide diethanolamine, etc.), fatty acid esters of glycerol (e.g., glycerol monostearate, glyercol monolaurate, etc.), fatty acid esters of sorbitol (e.g., sorbitan monolaurate, sorbitan monostearate, sorbitan tristearate, etc.), alkyl polyglycosides (e.g., decyl glucoside, lauryl glucoside, octyl glucoside, etc.), block copolymers of polyethylene glycol and polypropylene glycol, glycerol alkyl esters, alkyl polyglucosides, polyoxyethylene glycol octylphenol ethers, sorbitan alkyl esters, polyoxyethylene glycol sorbitan alkyl esters, and mixtures thereof. For instance, the non-ionic surfactant may include a polyethylene oxide condensate of an alkyl phenol (e.g., the condensation product of an alkyl phenol having an alkyl group containing from 6 to 12 carbon atoms in either a straight chain or branched chain configuration, with ethylene oxide (e.g., present in amounts equal to 1 to 40 moles)). The alkyl substituent may be derived, for example, from polymerized propylene, di-isobutylene, octane or nonene. Other examples include dodecylphenol condensed with 12 moles of ethylene oxide per mole of phenol; dinonylphenol condensed with 5 moles of ethylene oxide per mole of phenol; nonylphenol condensed with 9 moles of ethylene oxide per mole of nonylphenol and di-iso-octylphenol condensed with 5 moles of ethylene oxide. The non-ionic surfactant may be a condensation product of a primary or secondary aliphatic alcohol having from 8 to 24 carbon atoms, in either straight chain or branched chain configuration, with from 1 to about 40 moles of alkylene oxide per mole of alcohol. The non-ionic surfactant may include a compound formed by condensing ethylene oxide with a hydrophobic base formed by the condensation of propylene oxide with propylene glycol (e.g., Pluronics). In one embodiment, the surfactant may be a silicon surfactant such as a polyether-modified siloxane.

In some aspects, a surfactant may include an ethoxylated alcohol that may include carbon chain lengths ranging from 12 to 20 carbon atoms. For instance, an ethoxylated alcohol may include carbon chain lengths ranging from 12 to 20 carbon atoms. A surfactant may include a blend of ethoxylated alcohols that have carbon chain lengths ranging from 12 to 20 carbon atoms. For instance, surfactant may include a blend of ethoxylated alcohols having carbon chain lengths ranging from 12 to 20 carbon atoms.

In one embodiment, the surfactant may include a cationic surfactant. For instance, the surfactant may include a cationic surfactant such as water- soluble quaternary ammonium compounds, polyammonium salts, a polyoxyethylene alkylamine and the like. In some aspects, the surfactant may include a cationic surfactant such as a quaternary ammonium salt (e.g., cetrimonium bromide, cetylpyridinium chloride, benzalkonium chloride, benzethonium chloride, dimethyldioctadecylammonium chloride, and dioctadecyldimethylammonium bromide, etc.).

Notably, the additives of the gypsum slurry and/or gypsum core may include a starch. The starch may be one generally utilized in the art. Such starch may be combined with the stucco and water. In this regard, such starch may be present in the gypsum slurry as well as the resulting gypsum core and gypsum panel. In one aspect, one or more components of a gypsum panel may be free of starch. For instance, the gypsum core and/or gypsum slurry may be free of starch. In one aspect, a gypsum panel formed in accordance with the present disclosure may be free of starch.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example, in one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more. The gelling temperature may be 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively lower gelling temperature. Meanwhile, without intending to be limited by theory, modifications of the hydroxyl group, such as by replacement via ethoxylation, ethylation, oxidation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In one aspect, the starch may be present in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

The manner in which the components (e.g., stucco, gypsum, water) for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer or pinless mixer. In this regard, the manner in which the components are incorporated into the gypsum slurry is not necessarily limited by the present invention. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soap may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a crystalline matrix of calcium sulfate dihydrate. In this respect, the stucco may convert into calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device to undergo a drying process. For instance, such a heating or drying device may be a kiln and may allow for removal of any free water. The temperature and time required for drying in a heating device is not necessarily limited by the present invention.

In one embodiment, the gypsum core may include a first gypsum core layer and a second gypsum core layer. The first gypsum core layer may be between the first facing material (e.g., front of the gypsum panel) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material (e.g., back of the gypsum panel). Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

The present disclosure is also directed to a method of forming and/or constructing a wallboard assembly. The method may comprise forming or providing a first wallboard, such as a gypsum panel in accordance with the present disclosure. The method may comprise providing an installed wallboard (e.g., a second wallboard) attached to a building wall or ceiling. The method may also include a further step of attaching, fastening, and/or affixing the first wallboard (e.g., a gypsum panel) to the installed or existing wallboard.

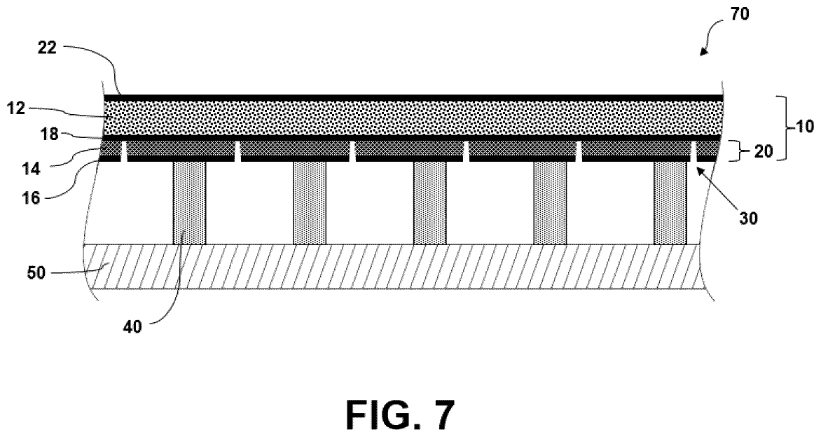

As illustrated in FIG. 7, a wallboard assembly 70 in accordance with the present disclosure may include a gypsum panel 10 that is fastened to one or more studs 40. The gypsum panel 10 may include two facing materials 20,22 and a gypsum core 12. The facing material 20 is a multilayer facing material having a first layer 18, a second layer 14, and a third layer 16. Notably, in FIG. 7, the first layer 18 is a paper facing material, the second layer 14 is a viscoelastic polymer, and the third layer 16 is a paper facing material. As illustrated in FIG. 7, a plurality of perforations 30 are present in the third layer 16 and the second layer 14 of the multilayer facing material 20. In the embodiment shown in FIG. 7, the building structure is a vertically aligned building wallboard assembly 70, which optionally has a second installed wallboard 50 connected to an opposite side of the gypsum panel 10. The gypsum panel 10 and the second installed wallboard 50 may be connected via one or more studs 40 of a wallboard assembly 70.

The gypsum panel disclosed herein may have many applications. For instance, the gypsum panel may be used as a standalone panel in construction for the preparation of walls, ceilings, floors, roofing, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

In one embodiment, the gypsum panel may be processed such that any respective gypsum core layer may have an average void size of about 50 microns to about 1200 microns, such as about 50 microns or more, such as about 100 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more, such as about 700 microns or more, such as about 800 microns or more. Generally, the average void size may be about 1200 microns or less, such as about 1100 microns or less, such as about 1000 microns or less, such as about 900 microns or less, such as about 800 microns or less, such as about 700 microns or less, such as about 600 microns or less, such as about 50 0microns or less, such as about 400 microns or less, such as about 300 microns or less, such as about 200 microns or less, such as about 100 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 15 m²/g, including all increments of 0.01 m²/g therebetween. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, the thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more, such as about 1600 lbs/MSF or more, such as about 1800 lbs/MSF or more, such as about 2000 lbs/MSF or more, such as about 2200 lbs/MSF or more, such as about 2400 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396-17. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396-17. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396-17 and ASTM C473-19. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20lb_{f} or less, such as about 18 lb_{f} or less, such as about 15 lb_{f} or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising:
a gypsum core comprising gypsum;
a first facing material and a second facing material, the first facing material, the second facing material, or both being a multilayer facing material, wherein at least one multilayer facing material of the gypsum panel comprises a polymer; and
one or more perforations, the one or more perforations having a variable diameter or a variable width over at least a portion of a length of the one or more perforations, the one or more perforations being present in the at least one multilayer facing material.

2. The gypsum panel of claim 1, wherein the one or more perforations have a width or a diameter from about 0.1 mm to about 50 mm.

3. The gypsum panel of claim 1, wherein the one or more perforations comprise two adjacent perforations, the two adjacent perforations being spaced from each other by a distance of about 200 mm on center or less.

4. The gypsum panel of claim 1, wherein the one or more perforations comprise two adjacent perforations, the two adjacent perforations being spaced from each other by a distance from about 1 mm on center or more to about 100 mm on center or less.

5. The gypsum panel of claim 1, wherein the at least one multilayer facing material comprises a polymer.

6. The gypsum panel of claim 1, wherein the at least one multilayer facing material comprises paper.

7. The gypsum panel of claim 1, wherein the one or more perforations comprise at least three perforations that are in-line, the at least three perforations forming a row parallel with the width of the gypsum panel.

8. The gypsum panel of claim 1, wherein the one or more perforations comprise at least two perforations that are staggered.

9. The gypsum panel of claim 1, wherein the one or more perforations are present in two or more layers of the at least one multilayer facing material.

10. The gypsum panel of claim 1, wherein the one or more perforations are not present in every layer of the at least one multilayer facing material.

11. The gypsum panel of claim 1, wherein the at least one multilayer facing material comprises a layer closest to the gypsum core, wherein the one or more perforations are not present in the layer of the at least one multilayer facing material closest to the gypsum core.

12. The gypsum panel of claim 1, wherein at least a portion of at least one perforation is tapered, the at least one perforation having a perforation taper angle of about 0.5° or more.

13. The gypsum panel of claim 1, wherein the one or more perforations are in the form of a polyhedron.

14. The gypsum panel of claim 1, wherein the one or more perforations define a hollow or annular shape that includes a remaining portion of a facing material layer of the multilayer facing material.

15. The gypsum panel of claim 1, wherein:
the at least one multilayer facing material comprises a layer closest to the gypsum core, wherein the one or more perforations are not present in the layer of the at least one multilayer facing material closest to the gypsum core; and
at least a portion of at least one perforation is tapered, the at least one perforation having a perforation taper angle of about 0.5° or more.

16. A gypsum panel comprising:
a gypsum core comprising gypsum;
a first facing material and a second facing material, the first facing material, the second facing material, or both being a multilayer facing material;
wherein at least one multilayer facing material comprises a first facing material layer and a second facing material layer, the first facing material layer being an inner facing material layer closest to the gypsum core; and
one or more perforations, the one or more perforations being present in the at least one multilayer facing material, the one or more perforations not being present in the first facing material layer.

17. The gypsum panel of claim 16, wherein the at least one multilayer facing material comprises a third facing material layer, the third facing material layer being an outer facing material layer.

18. The gypsum panel of claim 17, wherein the second facing material layer comprises a polymer.

19. A method for making a gypsum panel comprising:
providing a first facing material;
depositing a gypsum slurry comprising stucco and water onto the first facing material;
providing a second facing material on the gypsum slurry; and
allowing the stucco to convert to calcium sulfate dihydrate;
wherein the first facing material, the second facing material, or both are a multilayer facing material;
wherein the method further comprises forming one or more perforations in at least one multilayer facing material, the one or more perforations having a variable diameter or a variable width over at least a portion of the length of the one or more perforations;
wherein the gypsum slurry forms a gypsum core.

20. The method of claim 19, wherein:
the at least one multilayer facing material comprises a layer closest to the gypsum core, wherein the one or more perforations are not present in the layer of the at least one multilayer facing material closest to the gypsum core; and
at least a portion of at least one perforation is tapered, the at least one perforation having a perforation taper angle of about 0.5° or more.

21. The method of claim 20, wherein the at least one multilayer facing material comprises a first facing material layer and a second facing material layer, the second facing material layer comprising a polymer.

22. The method of claim 19, wherein the one or more perforations are formed in the at least one multilayer facing material prior to providing the first facing material.

23. The method of claim 19, wherein the one or more perforations are formed in the at least one multilayer facing material after providing the second facing material.

24. The method of claim 19, wherein the one or more perforations are formed in an offline process.
